(19) United States
(12) Patent Application Publication
(10) Pub. No.: US 2020/0251296 A1
(43) Pub. Date: Aug. 6, 2020

(54) REED SWITCH ASSEMBLY HAVING A CUSTOMIZABLE LENGTH OF ACTIVATION

(71) Applicant: Honeywell International Inc., Morris Plains, NJ (US)

(72) Inventor: Jeffrey ALEXANDER, Atlanta, GA (US)

(73) Assignee: Honeywell International Inc.

(21) Appl. No.: 16/268,632

(22) Filed: Feb. 6, 2019

(51) Int. Cl. H01H 51/28; H01H 50/18; H01H 50/44; H01H 50/54

(52) U.S. Cl. CPC H01H 51/282; H01H 50/18; H01H 50/023; H01H 50/54; H01H 50/44

(57) ABSTRACT

A reed switch assembly having a customizable length of activation is disclosed. One embodiment of the reed switch assembly may comprise a reed switch comprising a first reed contact, a second reed contact, a reed switch body enclosing the first reed contact and the second reed contact, and a bias magnet. The bias magnet may be positioned a certain distance away from the reed switch body to close the reed switch by a magnetic field. The reed switch assembly may further comprise a diversion blade that is configured to move in and out of a space between the reed switch body and the bias magnet. The diversion blade positioned in the space may open the reed switch by diverting the magnetic field applied by the bias magnet.

### TECHNICAL FIELD

The present disclosure relates to a reed switch assembly that may be used in a variety of contexts. More particularly, the present disclosure relates to a normally-closed reed switch assembly that may be customized to provide a desired length of activation.

### BACKGROUND

A reed switch is an electrical switch operated by an applied magnetic field. One of the most common types is a Single Pole Single Throw (SPST) reed switch, which consists of a pair of contacts on ferromagnetic metal reeds in a hermetically sealed glass envelope (i.e., reed switch body). The contacts may be normally open, closing when a magnetic field is applied (i.e., a normally-open SPST reed switch), or normally closed, opening when a magnetic field is applied (i.e., a normally-closed SPST reed switch). The reed switch effectively works like a gate, or a bridge, in an electric circuit. When the contacts are closed, electricity can flow around the circuit to operate a device.

The current state of the art to operate a normally-closed SPST reed switch is by using two magnets. A fixed magnet is collocated near the reed switch body (e.g., attached to the reed switch body) to have the contacts closed, until an opposing magnetic field is applied by a bias magnet to open the contacts. Due to the close proximity of the fixed magnet to the contacts, the size, type, and position of the fixed magnet may be carefully considered to maintain the contacts stabilized in the closed or open position. Further, with either the normally-closed SPST reed switch or the normally-open SPST reed switch of the current state of the art, the physical distance of activation (i.e., being in an abnormal position) is limited.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE INVENTION

One embodiment provides a reed switch assembly comprising: a reed switch comprising: a first reed contact; a second reed contact; a reed switch body defining a substantially straight channel and enclosing the first reed contact and the second reed contact; and a bias magnet positioned a certain distance away from the reed switch body to close the reed switch by a magnetic field; and a diversion blade configured to move in and out of a space between the reed switch body and the bias magnet, such that the diversion blade positioned in the space opens the reed switch by diverting the magnetic field applied by the bias magnet.

One embodiment provides a reed switch assembly comprising: a reed switch comprising: a first reed contact; a second reed contact; a reed switch body defining a substantially straight channel and enclosing the first reed contact and the second reed contact; and a bias magnet positioned a certain distance away from the reed switch body to close the reed switch by a magnetic field; and a yoke configured to move and surround the bias magnet, such that the yoke, when moved into a position to surround the bias magnet, opens the reed switch by diverting the magnetic field applied by the bias magnet.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

Embodiments of the present disclosure will now be described, by way of example only, with reference to the accompanying drawings in which:

FIG. 1A shows a view along the x-y plane of a normally-closed SPST reed switch assembly in a “normal” state.

FIG. 1B shows a view along the x-y plane of a normally-closed SPST reed switch assembly in an “abnormal” state.

FIG. 1C shows a view along the x-y plane of a normally-closed SPST reed switch assembly in an “overdriven” state.

FIG. 2A shows a view along the x-y plane of an exemplary normally-closed SPST reed switch assembly in a “normal” state, according to one aspect of the present disclosure.

FIG. 2B shows the exemplary normally-closed SPST reed switch assembly of FIG. 2A along the y-z plane, according to one aspect of the present disclosure.

FIG. 2C shows a view along the x-y plane of an exemplary normally-closed SPST reed switch assembly in an “abnormal” state, according to one aspect of the present disclosure.

FIG. 2D shows the exemplary normally-closed SPST reed switch assembly of FIG. 2C along the y-z plane, according to one aspect of the present disclosure.

FIG. 3 shows a perspective view of an exemplary normally-closed SPST reed switch device, according to one aspect of the present disclosure.

FIG. 4A shows a perspective view of the exemplary normally-closed SPST reed switch device of FIG. 3 implemented with a yoke, according to one aspect of the present disclosure.

FIG. 4B shows a view along the x-y plane of the exemplary normally-closed SPST reed switch and the yoke depicted in FIG. 4A, according to one aspect of the present disclosure.

FIG. 5A shows a perspective view of the exemplary normally-closed SPST reed switch device and the yoke depicted in FIG. 4A, with the yoke being attached to a rotational object, according to one aspect of the present disclosure.

FIG. 5B shows another perspective view of the exemplary normally-closed SPST reed switch device and the yoke depicted in FIG. 4A, with the yoke being attached to a rotational object, according to one aspect of the present disclosure.

FIG. 6A show a perspective view of the exemplary normally-closed SPST reed switch device of FIG. 3 implemented with a yoke, according to one aspect of the present disclosure.

FIG. 6B shows a view along the x-y plane of the exemplary normally-closed SPST reed switch and the yoke depicted in FIG. 6A, according to one aspect of the present disclosure.

FIG. 7A shows a perspective view of the exemplary normally-closed SPST reed switch of FIG. 3 implemented with a diversion blade, according to one aspect of the present disclosure.

FIG. 7B shows a perspective view of the exemplary normally-closed SPST reed switch of FIG. 3 implemented with a diversion blade that is configured differently from the diversion blade of FIG. 7A, according to one aspect of the present disclosure.

### DETAILED DESCRIPTION

The following embodiments describe a reed switch assembly that may be used in a variety of contexts. More particularly, the following embodiments relate to a normally-closed SPST reed switch assembly that may be customized to provide a desired length of activation.

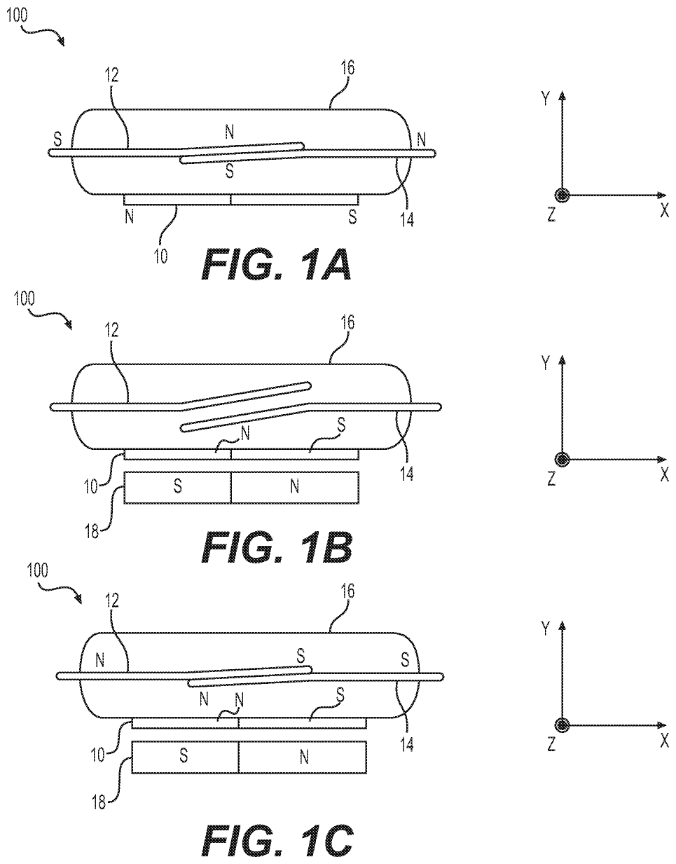

The SPST reed switch is inherently normally open. Second party vendors add bias magnets within the reed switch packaging to transform the normally-open SPST reed switch to a normally-closed SPST reed switch. FIG. 1A shows a view along the x-y plane of a normally-closed SPST reed switch assembly in a “normal” state. In general, a normally-closed SPST reed switch assembly 100 may include a first reed contact 12, a second reed contact 14, a reed switch body 16, a bias magnet 10, and a switching magnet 18 (not shown in FIG. 1A, but shown in FIGS. 1B-1C). In the “normal” or “closed” state, the first reed contact 12 and the second reed contact 14 may be magnetically polarized by the magnetic field generated by the bias magnet 10, which may be attached to the outer surface of the reed switch body 16. Due to the magnetic polarization, contacts 12 and 14 become magnetically attracted to each other, closing the switch.

FIG. 1B shows a view along the x-y plane of a normally-closed SPST reed switch assembly in an “abnormal” state. In the “abnormal” or “open” state, the first reed contact 12 and the second reed contact 14 may be depolarized by the magnetic field generated by a switching magnet 18, which counters the magnetic field strength and polarity generated by the bias magnet 10 to open the switch. When the switching magnet 18 is moved close to the reed switch body 16, contacts 12 and 14 may repel one another due to the opposing magnetic field generated by the switching magnet 18, opening the switch.

The direction and the strength of the magnetic field (i.e., magnetic flux) generated by the switching magnet 18 may need to be precisely controlled to switch the state of the reed switch from “closed” to “open,” and to keep it open in a stable manner. In other words, the magnetic polarization of the contacts 12 and 14, which is induced by the bias magnet 10, needs to be correctly countered/canceled by the switching magnet 18, by generating an opposing magnetic field of specific direction and strength. For instance, if the field is too weak, the switch will not open. On the other hand, if the field is too strong, the switch will be overdriven and become closed, with the contacts 12 and 14 polarized in the opposite direction (compared to FIG. 1A). FIG. 1C depicts a view along the x-y plane of a normally-closed SPST reed switch assembly in such an “overdriven” state. Therefore, the magnetic field generated by the switching magnet 18 needs to remain in direct opposition to that of the bias magnet 10, and stay within a set value of opposition strength.

The magnetic field strength of the bias magnet 10 may need to be substantially smaller compared to that of the switching magnet 18, due to the close proximity of the bias magnet 10 to the reed contacts 12 and 14. Due to this limitation, the magnetic material of choice for the bias magnet 10 may be ceramic (e.g., Strontium Ferrite). Ceramic magnets may not be nearly as stable against varying temperature (e.g., high temperature) as magnets composed of other temperature-stable materials. For instance, ceramic magnets may have magnetic strength temperature coefficients ranging approximately from −0.2 to −0.3%/° C. The magnetic strength temperature coefficients represent the percent change in the intrinsic coercive field strength per degree Celsius. Because of the poor temperature linearity, the operational temperature range for the reed switch may be limited in applications requiring higher degrees of accuracy. The more temperature-stable magnets may be much higher powered (i.e., higher magnetic field strength) and may become fragile if used as the bias magnet 10 in the configuration shown in FIGS. 1A-1B, as the size of the magnet may need to be very small to achieve a desired strength (i.e., not to overdrive the proximately-positioned reed contacts 12 and 14).

With conventional normally-open or normally-closed SPST reed switches, the physical distance of activation (i.e., being in an “abnormal” state) may also be limited. For example, if a reed switch is set to pass over magnetic fields that change directions (e.g., pass over a line of magnets), the switch may flutter between “normal” and “abnormal” states. Maintaining a constant flux direction over an extended distance may not be possible with the conventional normally-closed SPST reed switch, and an elaborate circuit/assembly with back path yokes may be necessary for the normally-open SPST switch.

Therefore, there is a need for a reed switch assembly that is compatible with magnets of varying characteristics, such as, e.g., magnetic strengths and temperature coefficients. Further, it would be desirable to have a customizable reed switch assembly, to facilitate customizing the distance and/or duration of the reed switch activation.

One disclosed embodiment is directed to a normally-closed SPST reed switch assembly comprising a reed switch and a diversion blade. In particular, the reed switch may comprise a bias magnet positioned a certain distance away from a reed switch body enclosing reed contacts. The diversion blade may be configured to be mobile, such that the diversion blade may be positioned between the bias magnet and the reed switch body for a desired distance and/or duration. Thus, the disclosed embodiment may allow use of a more powerful, temperature-stable magnet compared to that of, for example, the reed switch assembly 100 depicted in FIGS. 1A-1C, and may allow for a customizable activation distance/duration.

The subject matter herein will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

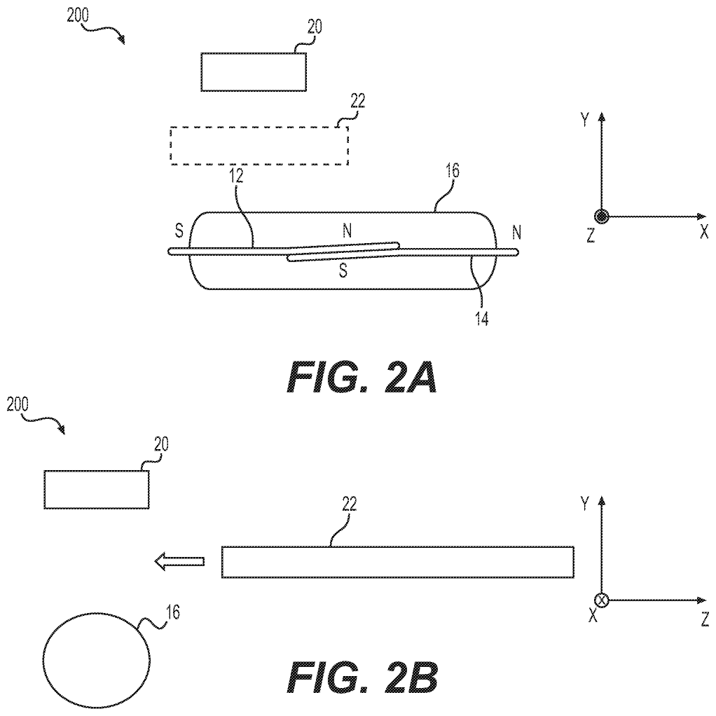

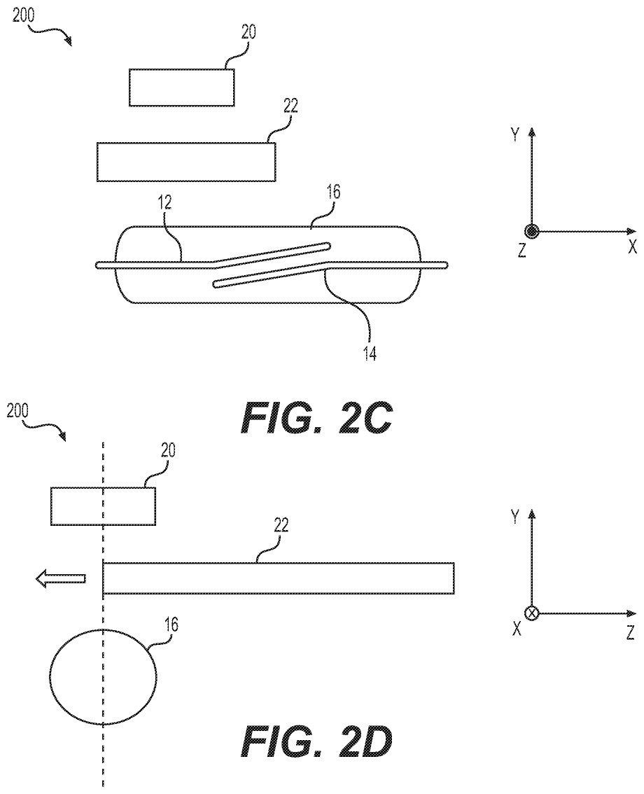

Referring now to the drawings illustrative of the contemplated embodiments, FIG. 2A shows a view along the x-y plane of an exemplary normally-closed SPST reed switch assembly in a “normal” state, according to one aspect of the present disclosure. FIG. 2B shows the exemplary normally-closed SPST reed switch assembly of FIG. 2A along the y-z plane, according to one aspect of the present disclosure. In the discussion below, reference will be made to both FIG. 2A and FIG. 2B. In general, the normally-closed SPST reed switch assembly 200 may comprise a first reed contact 12, a second reed contact 14, a reed switch body 16, a bias magnet 20, and a diversion blade 22. Notably, the normally-closed SPST reed switch assembly 200 may use a single magnet (e.g., only the bias magnet 20) and a diversion blade 22, to close and open the switch.

In the “normal” or “closed” state, the first reed contact 12 and the second reed contact 14 may be magnetically polarized by a magnetic field generated by the bias magnet 20. Due to the magnetic polarization, contacts 12 and 14 become magnetically attracted to each other, closing the switch. Notably, the bias magnet 20 may not be attached to the reed switch body 16, and may be positioned a certain distance away from the reed switch body 16. Positioning the bias magnet 20 “away” from the reed switch body 16 and keeping a certain amount of distance therebetween may allow the use of a more temperature-stable, higher-powered magnet as the bias magnet 20, because the risk of overdriving the reed contacts 12 and 14 may be reduced or minimized under this configuration. For example, more powerful, standard size temperature-stable magnets such as, e.g., Sumarium Cobalt, which has a magnetic strength temperature coefficient of approximately −0.04%/° C., may be used as the bias magnet 20, due to the greater physical separation from the reed contacts 12 and 14. Another material of choice is Neodymium. Each of Sumarium Cobalt and Neodymium may have sufficient magnetic strength to be used at separation distances (i.e., distance between the bias magnet 20 and the reed contacts 12 and 14) up to and likely greater than 0.25 inches. However, the material of the bias magnet 20 may not be limited to Sumarium Cobalt and Neodymium. Weaker magnets formed of temperature-stable Alnico or less temperature-stable Ceramic (e.g., Hexagonal Ferrite) may also be used in applications where closer separation is acceptable. Nonetheless, the stronger and more temperature-stable Sumarium Cobalt or Neodymium that allows for i) a greater physical separation from the reed contacts 12 and 14 (such that the blade 22 may not mechanically interfere with the reed switch body 16 over the travel distance) and ii) a wider operational temperature range may be preferred. The perpendicular distance (i.e., the shortest distance) between the bias magnet 20 and the reed switch body 16 may be large enough to pass a diversion blade 22 through the space between the bias magnet 20 and the reed switch body 16. In other words, the perpendicular distance may be larger than the thickness of the diversion blade 22.

It should be noted that the diversion blade 22 in FIG. 2A is illustrated as a dotted box, because the diversion blade 22 has not been positioned between the bias magnet 20 and the reed switch body 16 yet. This is shown more clearly in FIG. 2B. As shown in FIG. 2B, when the reed switch is in the “normal” or “closed” state, the diversion blade 22 may not be positioned between the bias magnet 20 and the reed switch body 16, either partially or entirely. Therefore, the magnetic field generated by the bias magnet 20 is not interfered by any object and may polarize the reed contacts 12 and 14 to attract each other. However, as indicated by the arrow next to the diversion blade 22 in FIG. 2B, the diversion blade 22 may be moved along the z-axis and may be positioned between the bias magnet 20 and the reed switch body 16, as discussed below in greater detail.

FIG. 2C shows a view along the x-y plane of an exemplary normally-closed SPST reed switch assembly in an “abnormal” state, according to one aspect of the present disclosure. FIG. 2D shows the exemplary normally-closed SPST reed switch assembly of FIG. 2C along the y-z plane, according to one aspect of the present disclosure. In the following discussion, reference will be made to both FIG. 2C and FIG. 2D.

In the “abnormal” or “open” state, the first reed contact 12 and the second reed contact 14 may be opened by positioning the diversion blade 22 in between the bias magnet 20 and the reed switch body 16. The diversion blade 22 may be made of soft magnetic material(s), which have low retentivity and low coercivity, such as, e.g., Iron-Silicon alloys, Nickel-Iron alloys, Iron, etc. These soft magnetic materials may also have high initial permeability, low hysteresis loss, and large magnetic induction. Therefore, placement of the diversion blade 22 between the bias magnet 20 and the reed switch body 16 may suspend polarization of the reed contacts 12 and 14, by diverting the magnetic field generated by the bias magnet 20 away from the reed contacts 12 and 14. Because the reed contacts 12 and 14 are no longer polarized, they may revert to the “open” state as shown in FIG. 2C.

As shown in FIG. 2D, the diversion blade 22 may only need to be partially positioned between the bias magnet 20 and the reed switch body 16 along the z-axis, and may still be able to divert a sufficient portion of the magnetic field to depolarize and open the reed contacts 12 and 14. More particularly, the diversion blade 22 may be moved at least to the centerline position along the z-axis, as indicated by the dotted vertical line in FIG. 2D, to open the switch. As alluded to above, the diversion blade 22 may continue to move along the z-axis (e.g., move to left in FIG. 2D) at a desired rate, such that the switch remains open for a desire duration until the diversion blade 22 moves past the centerline. Therefore, the length/duration of the actuation may be decided based on the length of the diversion blade 22 as well as the rate of the movement, both of which may be customizable based on specific needs and applications. Diversion blade 22 may also be moved in the other direction, e.g., from left to right in FIG. 2D, and may achieve the same effects discussed above.

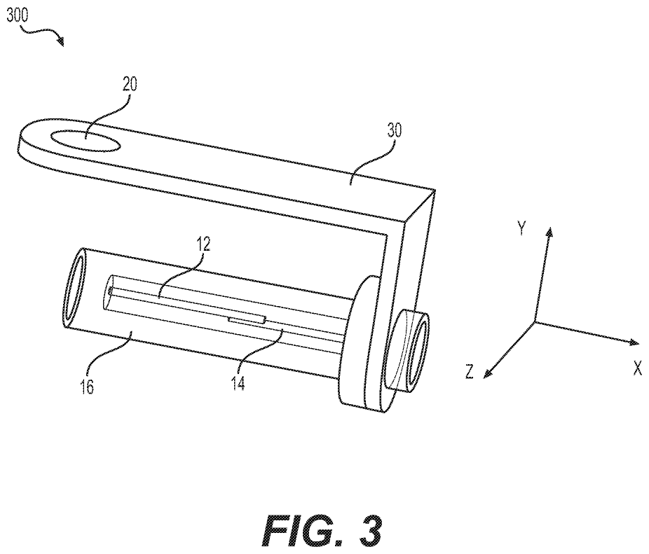

FIG. 3 shows a perspective view of an exemplary normally-closed SPST reed switch device, according to one aspect of the present disclosure. Notably, the reed switch device 300 may employ the concepts and configurations of the reed switch assembly 200 discussed above in reference to FIGS. 2A-2C. In general, the reed switch device 300 may comprise a reed switch body 16 enclosing a first reed contact 12 and a second reed contact 14, and a bracket 30 with a bias magnet 20 embedded therein.

As shown in FIG. 3, the reed contacts 12 and 14 may be encased in a reed switch body 16, which may be tubular, hermetically-sealed glass capsule filled with an unreactive gas (e.g., Nitrogen). In some embodiments, the reed switch body 16 may further comprise an outer casing made of plastic, to enclose and protect the glass capsule from damage. The reed contacts 12 and 14 may be made of ferromagnetic material(s) and may be coated with a hard wearing metal such as, e.g., Rhodium or Ruthenium. In order to position the bias magnet 20 a certain distance away from the reed contacts 12 and 14, an object may be used to hold the bias magnet 20 at a desired location relative to the reed switch body 16. An optimal location may be chosen such that the bias magnet 20 held at the selected location may close the contacts 12 and 14 (to achieve a “closed” state”) in the absence of any obstructing object (e.g., diversion blade 22), and such that a diversion blade 22 may move in and out of the space between the bias magnet 20 and the reed switch body 16. The object used to hold the bias magnet 20 may be attached to the reed switch body 16. For example, as shown in FIG. 3, a bracket 30 attached to the reed switch body 16 may be used to hold the bias magnet 20 at the optimal location. In other embodiments, the object used to hold the bias magnet 20 may not be attached to the reed switch body 16, and may be attached to a structure independent and/or separate from the reed switch body 16. Regardless of the type of object used to hold the bias magnet 20, the position of the bias magnet 20 relative to the reed contacts 12 and 14 needs to be maintained at the optimal location, such that the reed switch may remain closed in a stable manner during the “closed” state (i.e., without fluttering between “closed” and “open” states).

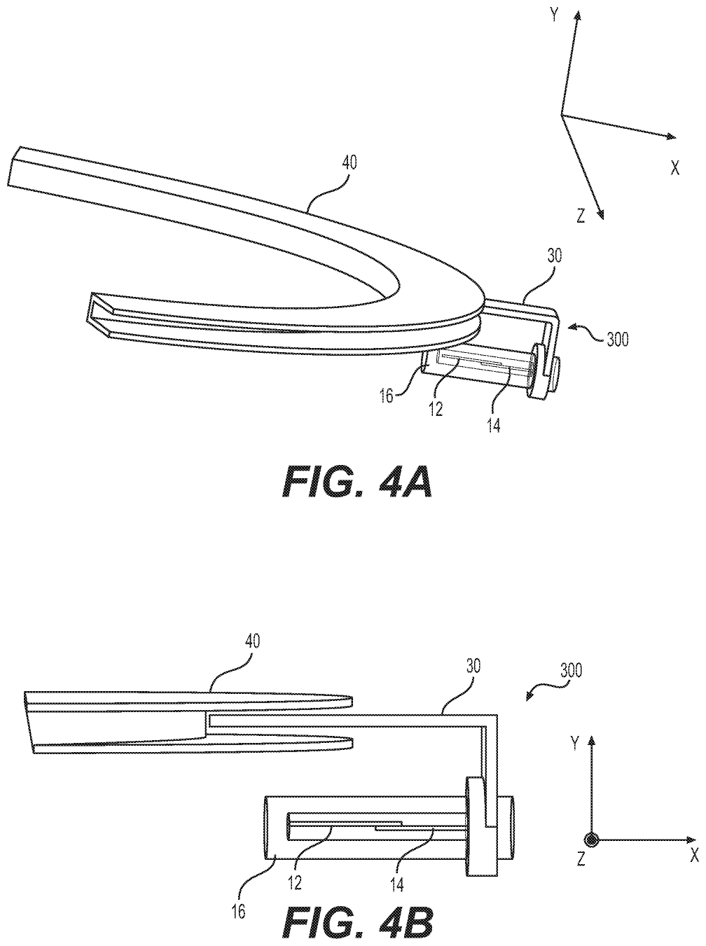

FIG. 4A shows a perspective view of the exemplary normally-closed SPST reed switch device of FIG. 3 implemented with a yoke, according to one aspect of the present disclosure. FIG. 4B shows a view along the x-y plane of the exemplary normally-closed SPST reed switch and the yoke depicted in FIG. 4A. Notably, yoke 40 may be employed to achieve the same, or substantially similar effect as the diversion blade 22 discussed above in reference to FIGS. 2A-2D. Reference will be made to both FIG. 4A and FIG. 4B in the discussion below.

As shown in FIG. 4B, yoke 40 may be a U-shaped soft magnetic object, with the opposing plates (i.e., the top and bottom plates) and the interconnecting blade (i.e., the plate that connects the top and bottom plates) configured to surround the bias magnet 20 embedded in the bracket 30. In addition to diverting the magnetic flux away from the reed switch body 16 via the bottom plate, the yoke 40 may confine largely the magnetic flux generated by the bias magnet 20 to the space enclosed within the U-shaped structure. As a result, the yoke 40 may provide an additional benefit of preventing stray magnetic fields from interfering with other magnetically sensitive devices nearby. When the yoke 40 is moved into position as shown in FIGS. 4A-4B (i.e., positioned such that the plates at least partially surround the bias magnet 40, e.g., at least up to the centerline discussed above with reference to FIG. 2D, in order to divert a sufficient amount of magnetic flux from the bias magnet 20 and open the reed switch), the contacts 12 and 14 may become depolarized and revert to the “open” state. It should be noted that, although a noticeable space is not visible between the first reed contact 12 and the second reed contact 14 in FIGS. 4A-4B, the contacts 12 and 14 are actually separated, leaving a space therebetween. In reality, the space between the contacts 12 and 14 may be very small (e.g., merely a few microns) and may not be visible to the naked eye.

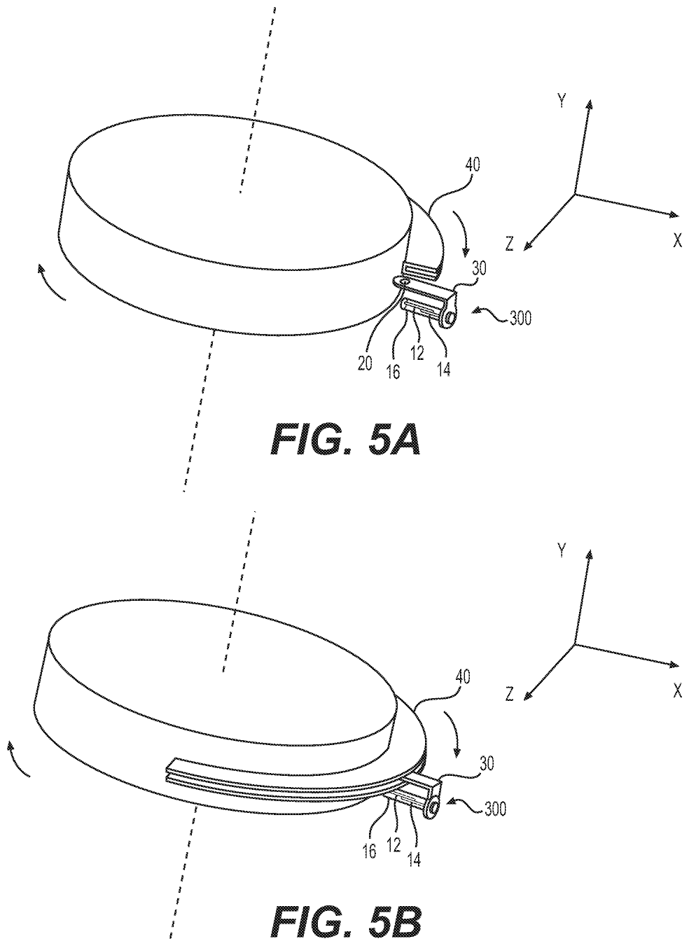

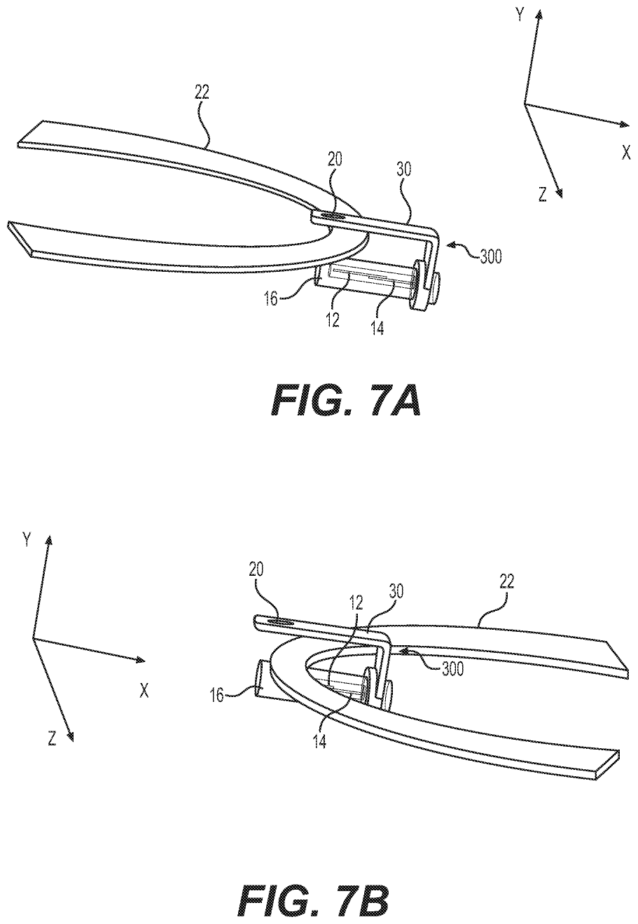

Further, as shown in FIG. 4A, yoke 40 may be curved or partially annular-shaped (i.e., arc-shaped). For example, yoke 40 may be partially annular-shaped and attached to an object that rotates around an axis. Such a rotational object may be cylindrical or cone-shaped, and the yoke 40 may be attached to the outer wall of the rotational device, as shown in FIGS. 5A-5B. FIG. 5A shows a perspective view of the exemplary normally-closed SPST reed switch device and the yoke depicted in FIG. 4A, with the yoke attached to a rotational object, according to one aspect of the present disclosure. In particular, the reed switch in FIG. 5A is in a “normal” or “closed” state, because the yoke 40 is not “in position” yet. FIG. 5B similarly shows a perspective view of the exemplary normally-closed SPST reed switch device and the yoke attached to a rotational object, but with the reed switch in an “abnormal” or “open” state (i.e., when the yoke 40 is “in position”). As shown in FIGS. 5A-5B, rotating the yoke 40 around an axis may transition the state of the reed switch between “closed” and “open” states. The length/duration of activation may depend on the length (i.e., circumferential length) of the yoke 40 and the rate of rotation around the axis, both of which may be customizable based on specific needs and/or applications. In some embodiments, the yoke 40 may not be attached to such an object depicted in FIGS. 5A-5B, and may rotate around an axis by using any suitable means. In some embodiments, the yoke 40 may be curved in a direction opposite to that of the curvature depicted in FIGS. 4A-4B and FIGS. 5A-5B, such that the axis by which the yoke 40 rotates may be on the other side of the reed switch device 300. For instance, FIGS. 7A-7B show a partially annular-shaped diversion blade 22 curved in opposite directions. Likewise, the curvature direction of the yoke 40 may be varied based on the application context.

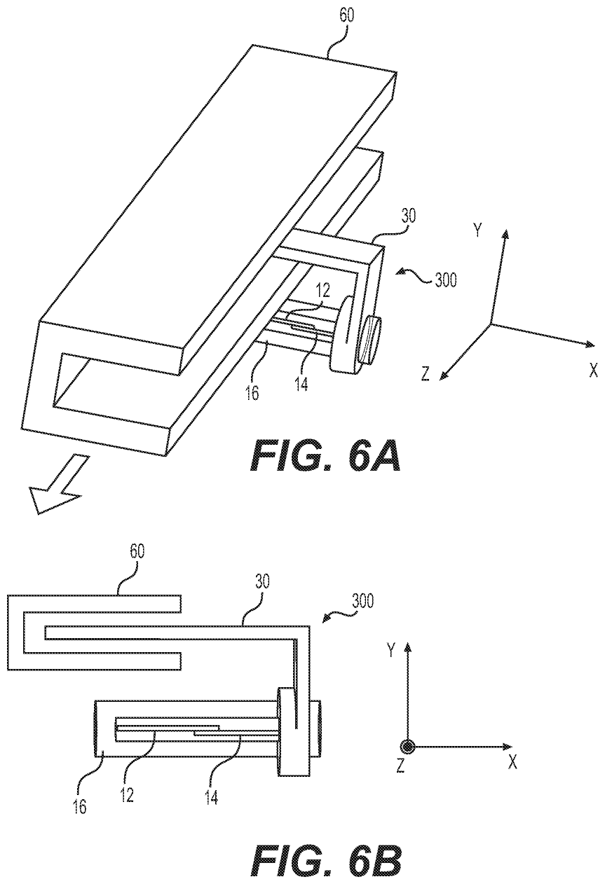

FIG. 6A show a perspective view of an exemplary normally-closed SPST reed switch device of FIG. 3 implemented with a yoke, according to another aspect of the present disclosure. FIG. 6B shows a view along the x-y plane of the exemplary normally-closed SPST reed switch and the yoke depicted in FIG. 6A. Notably, yoke 60 may be employed to achieve the same, or substantially similar effect as the diversion blade 22 discussed above in reference to FIGS. 2A-2D, and as the yoke 40 discussed above in reference to FIGS. 4A-4B. Further, while yoke 60 may operate in a similar manner as the yoke 40 depicted in FIGS. 4A-4B, the physical construction of the yoke 60 may be distinct from yoke 40, in that yoke 60 may be straight or substantially straight and may move linearly along an axis (as opposed to rotating around an axis). Reference will be made to both FIG. 6A and FIG. 6B in the discussion below.

As shown in FIG. 6B, yoke 60 may be a U-shaped soft magnetic object, with the opposing plates (i.e., the top and bottom plates) and the interconnecting blade (i.e., the plate that connects the top and bottom plates) configured to surround the bias magnet 20 embedded in the bracket 30. In addition to diverting the magnetic flux away from the reed switch body 16 via the bottom plate, the yoke 60 may confine largely the magnetic flux generated by the bias magnet 20 to the space enclosed within the U-shaped structure. Therefore, when the yoke 60 is moved into position (i.e., positioned such that the plates at least partially surround the bias magnet 40, e.g., at least up to the centerline discussed above with reference to FIG. 2D, in order to divert a sufficient amount of the magnetic flux from the bias magnet 20 and open the reed switch), the contacts 12 and 14 may become depolarized and revert to the “open” state. Further, as shown in FIG. 6A, yoke 60 may be straight or substantially straight, and may extend along an axis (e.g., z-axis). Yoke 60 may move linearly along the z-axis (in the positive z direction), as indicated by the arrow in FIG. 6A, to transition the state of the reed switch between “closed” and “open” states. Yoke 60 may also move in the opposite direction (in the negative z direction). The length/duration of activation may depend on the length of the yoke 60 and the rate of movement along the z-axis, both of which may be customizable based on specific needs and/or applications. Yoke 60 illustrated in FIGS. 6A-6B may operate under the same, or substantially similar principles as those explained with respect to FIGS. 4A-4B, except that yoke 60 may move in straight line along an axis, rather than rotating around an axis.

It is further noted that, in FIGS. 4A-4B, 5A-5B, and 6A-6B, the U-shaped object (e.g., yokes 40 and 60) is depicted as an exemplary device to divert the magnetic flux of the bias magnet 20. As explained above, a yoke may comprise three plates together forming a U-shaped configuration, to largely confine the magnetic flux within its enclosed space. However, an object shaped like the diversion blade 22 depicted in reference to FIGS. 2A-2D may also achieve the same effect of transitioning the state of the reed switch from “closed” to “open” (and vice versa). Diversion blade 22 may be a straight, planar, soft magnetic object that is configured to move in and out of the space between the bias magnet 20 and the reed switch body 16, to divert the magnetic flux from the bias magnet 20 away from the reed contacts 12 and 14. Like the yokes 40 and 60, the diversion blade 22 may be partially annular-shaped and may rotate around an axis, as shown in FIGS. 7A-7B, or may be straight or substantially straight and may move in straight line along an axis. In short, the operating principles explained with reference to FIGS. 4A-4B, 5A-5B, and 6A-6B (i.e., with respect to yokes 40 and 60) may equally apply to the diversion blade 22.

The particular embodiments disclosed above are illustrative only and should not be taken as limitations, as the embodiments may be modified and practiced in different but equivalent manners apparent to those skilled in the art having the benefit of the teachings herein. Accordingly, the foregoing description is not intended to limit the disclosure to the particular form set forth, but on the contrary, is intended to cover such alternatives, modifications, and equivalents as may be included within the spirit and scope of the inventions so that those skilled in the art should understand that they can make various changes, substitutions, and alterations without departing from the spirit and scope of the inventions in their broadest form.

Although various embodiments of the present disclosure have been illustrated and described in detail, it will be readily apparent to those skilled in the art that various modifications may be made without departing from the present disclosure or from the scope of the appended claims.

What is claimed is:

1. A reed switch assembly comprising:
a reed switch comprising:
a first reed contact;
a second reed contact;
a reed switch body defining a substantially straight channel and enclosing the first reed switch contact and the second reed switch contact; and
a bias magnet positioned a certain distance away from the reed switch body to close the reed switch by a magnetic field; and
a diversion blade configured to move in and out of a space between the reed switch body and the bias magnet, such that the diversion blade positioned in the space opens the reed switch by diverting the magnetic field applied by the bias magnet.

2. The reed switch assembly of claim 1, wherein the diversion blade is annular-shaped.

3. The reed switch assembly of claim 2, wherein the diversion blade is configured to rotate around an axis.

4. The reed switch assembly of claim 3, wherein the diversion blade extends only partially along a circumference relative to the axis, such that the rotation of the diversion blade around the axis opens and closes the reed switch.

5. The reed switch assembly of claim 1, wherein the diversion blade is substantially straight and elongated along an axis perpendicular to the reed switch body.

6. The reed switch assembly of claim 5, wherein the diversion blade is configured to move along the axis perpendicular to the reed switch body.

7. The reed switch assembly of claim 6, wherein the diversion blade has a finite length such that the movement of the diversion blade along the axis opens and closes the reed switch.

8. The reed switch assembly of claim 1, wherein the bias magnet is attached to an object that is separate from the reed switch body.

9. The reed switch assembly of claim 1, wherein the bias magnet is attached to a bracket that is attached to the reed switch body.

10. The reed switch assembly of claim 1, wherein the diversion blade is composed of soft magnetic materials having low retentivity and low coercivity.

11. The reed switch assembly of claim 1, wherein the diversion blade is attached to a rotational object.

12. The reed switch assembly of claim 1, wherein the diversion blade is configured to move linearly along an axis perpendicular to the reed switch body.

13. A reed switch assembly comprising:
a reed switch comprising:
a first reed contact;
a second reed contact;
a reed switch body defining a substantially straight channel and enclosing the first reed switch contact and the second reed switch contact; and
a bias magnet positioned a certain distance away from the reed switch body to close the reed switch by a magnetic field; and
a yoke configured to move and surround the bias magnet, such that the yoke, when moved into a position to surround the bias magnet, opens the reed switch by diverting the magnetic field applied by the bias magnet.

14. The reed switch assembly of claim 13, wherein the yoke is U-shaped when viewed from a first angle.

15. The reed switch assembly of claim 14, wherein the yoke is partially annular-shaped, when viewed from a second angle perpendicular to the first angle.

16. The reed switch assembly of claim 15, wherein the yoke is configured to rotate around an axis.

17. The reed switch assembly of claim 14, wherein the yoke is substantially straight and elongated along an axis perpendicular to the reed switch body, when viewed from a second angle perpendicular to the first angle.

18. The reed switch assembly of claim 17, wherein the yoke is configured to move linearly along the axis perpendicular to the reed switch body.

19. The reed switch assembly of claim 13, wherein the bias magnet is attached to an object that is separate from the reed switch body.

20. The reed switch assembly of claim 13, wherein the bias magnet is attached to a bracket that is attached to the reed switch body.
